(19) United States
(12) Patent Application Publication
(10) Pub. No.: US 2005/0212918 A1
(43) Pub. Date: Sep. 29, 2005

(54) Monitoring system and method

(76) Inventors: Bill Serra, Montara, CA (US); Salil Pradhan, San Jose, CA (US); Antoni N. Drudis, Saratoga, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/809,958

(22) Filed: Mar. 25, 2004

(51) Int. Cl. H04N 5/228; H04N 7/18; H04N 5/225; G06K 9/00

(52) U.S. Cl. 348/208.14; 348/169; 348/47; 348/153; 348/159; 348/211.11; 348/208.12; 382/103

(57) ABSTRACT

A monitoring system is provided. The system includes a plurality of sensor elements for distribution at a location and a plurality of cameras for capturing video data of the location. The system further includes a display unit for displaying a graphical representation of a network of the sensor elements throughout the location and a video stream from anyone of the cameras. The system further includes a navigation unit for navigating through the network of sensor elements displayed by the display unit, and a processing unit for selecting one of the cameras as the source of the video stream based on a current navigation position in the network of sensor elements.

### FIELD OF THE PRESENT INVENTION

The present invention relates broadly to a monitoring system, and more particularly to a method of monitoring a location and to a computer program comprising program code instructing a computer to perform a method of monitoring a location.

### BACKGROUND OF THE PRESENT INVENTION

Networks of computer accessible sensors and actuators are being used increasingly in various monitoring and controlling environments, such as in the security/safety domain, the asset management domain and the energy management domain. It is desirable to present the data from such networks in a manner which requires little expert input to derive useful information from the data for making appropriate decisions based on the data.

In current systems, an emphasis is to provide a virtual visualization of the obtained data and interactive control functionality utilizing computer graphics.

### SUMMARY OF THE PRESENT INVENTION

Briefly, a monitoring system is provided. It includes a plurality of sensor elements for distribution at a location and a plurality of cameras for capturing video data of the location. It further includes a display unit for displaying a graphical representation of a network of the sensor elements throughout the location and a video stream from any one of the cameras. It further includes a navigation unit for navigating through the network of sensor elements displayed by the display unit, and a processing unit for selecting one of the cameras as the source of the video stream based on a current navigation position in the network of sensor elements.

### BRIEF DESCRIPTION OF THE DRAWINGS

FIG. 1 is a schematic drawing of a monitoring and controlling system of an embodiment of the present invention.

FIG. 2 is a schematic drawing of a user interface unit of a monitoring and controlling system of an embodiment of the present invention.

FIG. 3 shows a flowchart illustrating a monitoring and controlling method of an embodiment of the present invention.

### DETAILED DESCRIPTION OF THE EMBODIMENTS

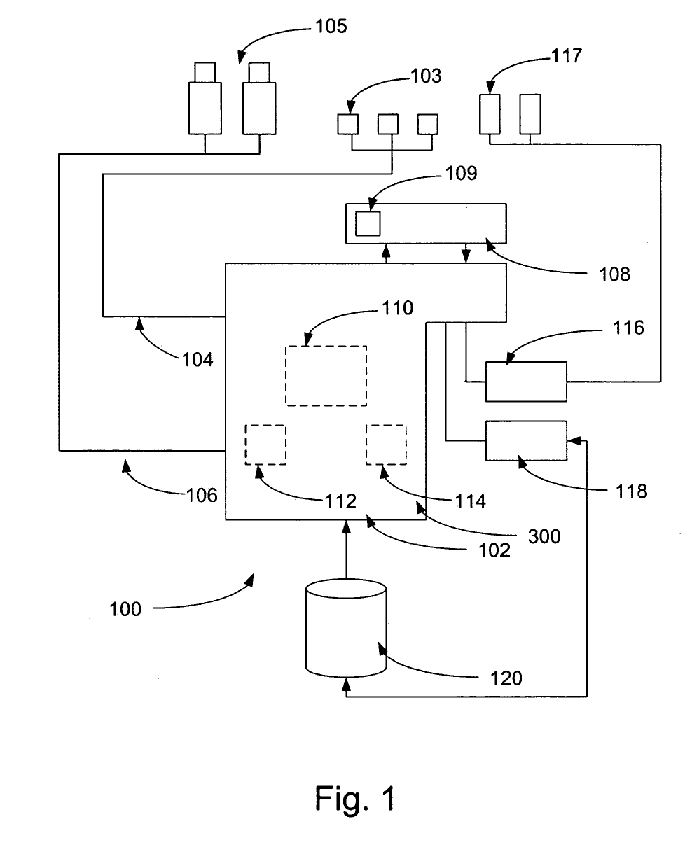

FIG. 1 shows a monitoring and controlling system 100 of an example embodiment. The system 100 includes a central unit 102 which receives data input from a network of sensors 103 at input 104. The central unit 102 further receives video data from a plurality of cameras 105 at input 106. A user interface unit 108 is interconnected with the central unit 102, for displaying a graphical representation of the network of sensors and their respective states to a user (not shown). The user interface unit 108 includes a navigating device 109 which enables the user to navigate through the graphical representation of the network of sensors.

The central unit 102 further provides a selected video stream to the user interface unit 108 for display to the user. The central unit 102 includes a processing unit 110 which controls a video stream selection unit 112 to provide a video stream from a selected one of the cameras 105 for display to the user, based on a current navigation position in the graphical representation of the sensor network 103. The video stream is chosen in the example embodiment such that it originates from a camera giving the “best” view of the current navigation position in the sensor network, thereby providing a ‘real’ video image of the graphical representation of the sensor network.

The processing unit 110 further controls a video mixing unit 112 to overlay a frame boundary onto the video stream of the selected camera 105, wherein the frame boundary corresponds to the actually displayed frame of the graphical representation of the sensor network 103.

In response to the simultaneous display of the graphical representation of the sensor network and the corresponding video stream, the user can provide input to the central unit 102 via the user interface unit 108. User actions are fed to an actuator driver 116 which in turn generates appropriate control signals to the network of actuators 117 to implement the desired user action. An adaptive reconfiguration driver unit 118 is also provided which enables an adaptive reconfiguration of configuration files stored in a database 120 of the system 100.

The adaptive reconfiguration driver unit 118 in the example embodiment has a standard application programming interface (API) for control applications. Thus, any external programmable unit which supports the same API can interface with the monitoring and controlling system 100 to decouple the network of actuators 117 from the network of sensors.

A commodity spreadsheet is used in the example embodiment. The spreadsheet receives data from the sensors. General spreadsheet techniques are used to manipulate the data received. The output of the spreadsheet is sent to a network of actuators.

The output is also stored in the database 120 and from the database 120 the data is sent to the central unit 102 to provide an adaptive environment. For example, if the moving average of the temperature at the corner of a room shows that said corner is consistently hotter than its surroundings, air vents near that corner can be gradually opened and other vents closed thus forcing cool air into the hot corner until the moving average temperature—as opposed to current temperature—has reached parity with the adjacent parts of the room.

It will be appreciated by a person skilled in the art that a programmable board or platform for a network of sensors and actuators may be implemented in a variety of ways in different embodiments of the present invention. For example, a control unit in another embodiment could be a programmable logic gate array (PLGA).

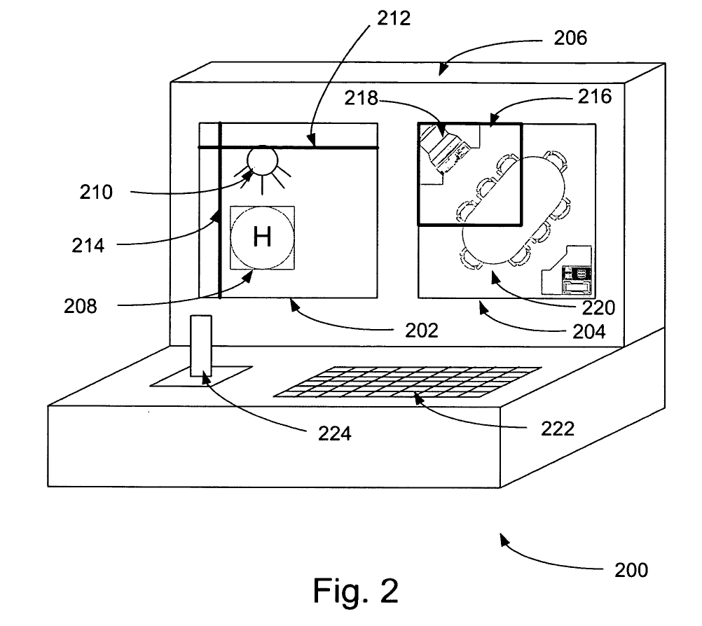

FIG. 2 shows a user interface unit 200 of an example embodiment. The interface unit 200 includes two screens 202, 204 arranged side by side on a display panel 206. One of the screens 202 displays a graphical representation of a network of sensors and actuators, e.g. smoke detector 208 and sprinkler 210. In the graphical representation of the network of sensors and actuators, room boundaries 212, 214 are incorporated into the graphics, representing an office environment in the context of a security/safety domain implementation in an example embodiment.

On the second screen 204, a video stream from a selected camera of a plurality of cameras (not shown) distributed across the office environment is displayed. A frame boundary 216 which matches the actual frame displayed on the other screen 202 showing the graphical representation of the sensor and actuator network is video mixed onto the video stream.

In an example scenario, the smoke detector 208 shows an alarm state indicating the presence of smoke in that area. From the graphical representation displayed on display 202, this is the extent of information available. However, in conjunction with the simultaneously displayed video stream on screen 204, that data can be put into a “real” context for a person stationed at the user interface unit 200.

Here, smoke would be seen to rise from the desktop computer 218 located in e.g. a boardroom 220. This confirms and clarifies the information gathered from the graphical representation of the sensor and actuator network on screen 202. Alternatively, the absence of visible smoke would provide an indication of a likely malfunctioning of the smoke detector 208.

In response to the confirmed safety hazard, the user could then activate the sprinkler 210, e.g. through input of suitable commands via keyboard 222. While the graphical representation on screen 202 may confirm that the sprinkler 210 now shows an activated state, the proper functioning can be confirmed visually on screen 204. The video stream would show whether or not water is dispensed from the sprinkler. Furthermore, the effectiveness or not for stopping smoke to emerge from the desktop computer 218 can be visually inspected, confirming whether or not the hazard has been successfully eliminated.

The user navigates through the graphical representation of the network of sensors and actuators displayed on screen 202 utilizing a joystick device 224 in the example embodiment. The frame boundary 216 video mixed onto the video stream displayed on screen 204 follows this movement under processor control. If the navigation changes beyond the field of view of a particular camera currently providing the video stream, the source of the display video stream is switched under processor control to a different camera. Again, the camera which provides the best view of the current navigation position in the graphical representation of the network of sensors and actuators on screen 202 is chosen.

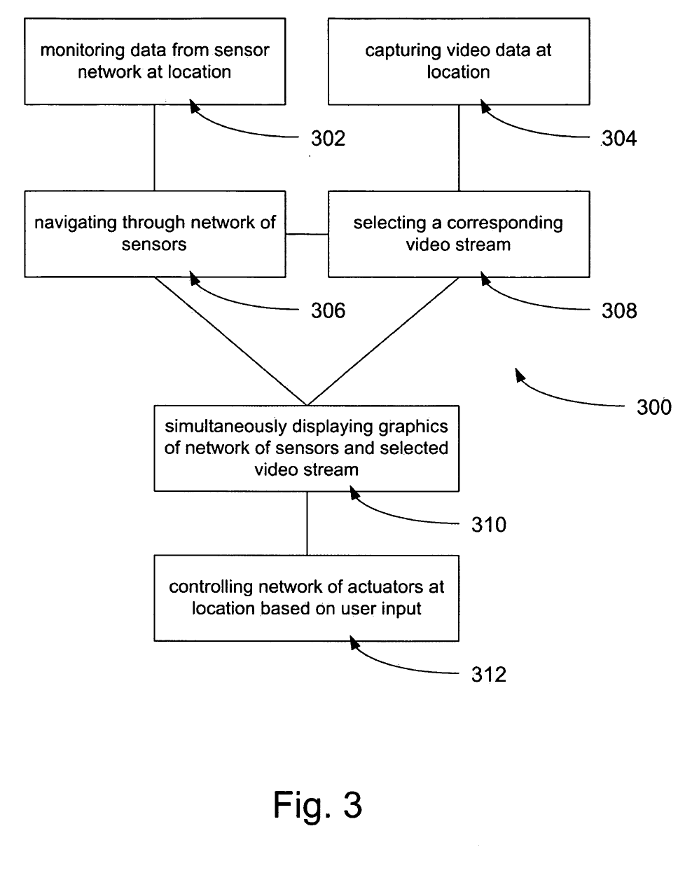

FIG. 3 shows a flowchart 300 of a monitoring and controlling method of an example embodiment. Data from a sensor network at a location is monitored at step 302. Concurrently, video data is captured at the location at step 304, utilizing a plurality of cameras.

A user navigates through the network of sensors at step 306 as part of a continued monitoring assignment. Based on a current navigating position in the network of sensors, a corresponding video stream from the video data captured is selected at step 308.

A graphical representation of the network of sensors and the selected video stream are simultaneously displayed to the user at step 310. The user is controlling a network of actuators at the location through appropriate user input at step 312 based on the information gathered from the simultaneously displayed graphics and video stream.

The above-described embodiment of the invention may also be implemented, for example, by operating a system to execute a sequence of machine-readable instructions. The instructions may reside in various types of computer readable media. In this respect, another aspect of the present invention concerns a programmed product, comprising computer readable media tangibly embodying a program of machine-readable instructions executable by a digital data processor to perform the method in accordance with an embodiment of the present invention.

This computer readable media may comprise, for example, RAM contained within the system. Alternatively, the instructions may be contained in another computer readable media (e.g. an image-processing module) and directly or indirectly accessed by the computer system. Whether contained in the computer system or elsewhere, the instructions may be stored on a variety of machine readable storage media, such as a Direct Access Storage Device (DASD) (e.g., a conventional “hard drive” or a RAID array), magnetic data storage diskette, magnetic tape, electronic non-volatile memory, an optical storage device (for example, CD ROM, WORM, DVD,), or other suitable computer readable media including transmission media such as digital, analog, and wireless communication links.

It will be appreciated by the person skilled in the art that numerous modifications and/or variations may be made to the present invention as shown in the specific embodiments without departing from the spirit or scope of the invention as broadly described. The present embodiments are, therefore, to be considered in all respects to be illustrative and not restrictive.

For example, it will be appreciated that while the example embodiments have been described in the context of the security/safety domain in e.g. an office environment, the present invention is not limited to a particular environment. Rather, it extends to any network of sensors and/or actuators at locations of which video data can be captured, including domains such as the asset management domain and the energy management domain.

Furthermore, it will be appreciated that the present invention applies to any type of sensor from which data can be centrally obtained and processed, and similarly to any actuator that can be remotely controlled.

1. A monitoring system comprising:
a plurality of sensor elements for distribution at a location,
a plurality of cameras for capturing video data of the location,
a display unit for displaying a graphical representation of a network of the sensor elements throughout the location and a video stream from any one of the cameras,
a navigation unit for navigating through the network of sensor elements displayed by the display unit, and
a processing unit for selecting one of the cameras as the source of the video stream based on a current navigation position in the network of sensor elements.

2. A system as claimed in claim 1, comprising:
a plurality of actuator elements for distribution at the location,
the display unit displaying a graphical representation of a network of the sensor and actuator elements,
the navigation unit enabling navigation through the network of sensor and actuator elements, and
a control unit for controlling the actuator elements through user input in response to information obtained from the graphical representation and the video stream.

3. A system as claimed in claim 1, the processing unit overlaying a frame boundary element over the video stream corresponding to a displayed frame of the graphical representation.

4. A system as claimed in claim 1, the control unit updating configuration data associated with the network of sensors and actuators in response to the user input.

5. A method of monitoring a location comprising the steps of:
obtaining monitoring data from a plurality of sensor elements distributed at the location,
capturing video data of the location utilizing a plurality of cameras,
navigating through a network of the sensor elements,
displaying a graphical representation of a current navigation position in the network of sensor elements, and
simultaneously displaying a video stream from one of the cameras selected based on the current navigation position.

6. A method as claimed in claim 5, comprising the steps of:
providing a plurality of actuator elements at the location,
displaying a graphical representation of a network of the sensor and the actuator elements,
navigating through the network of sensor and actuator elements, and
controlling the actuator elements in response to information obtained from the graphical representation and the video stream.

7. A method as claimed in claim 5, comprising overlaying a frame boundary element corresponding to a current displayed frame of the graphical representation on the video stream.

8. A method as claimed in claim 5, comprising updating configuration data associated with the network of sensors and actuators in response to the user input.

9. A computer program comprising program code instructing a computer to perform a method of monitoring a location, the method comprising the steps of:
obtaining monitoring data from a plurality of sensor elements distributed at the location,
capturing video data of the location utilizing a plurality of cameras,
navigating through a network of the sensor elements,
displaying a graphical representation of a current navigation position in the network of sensor elements, and
simultaneously displaying a video stream from one of the cameras selected based on the current navigation position.

10. A computer program as claimed in claim 9, wherein the method comprises the steps of:
displaying a graphical representation of a network of the sensor elements and a network of actuator elements at the location,
navigating through the network of sensor and actuator elements, and
controlling the actuator elements in response to information obtained from the graphical representation and the video stream.

11. A computer program as claimed in claim 9, wherein the method comprises overlaying a frame boundary element corresponding to a current displayed frame of the graphical representation on the video stream.

12. A computer program as claimed in claim 9, wherein the method comprises updating configuration data associated with the network of sensors and actuators in response to the user input.
